(19) United States
(12) Patent Application Publication
(10) Pub. No.: US 2007/0283418 A1
(43) Pub. Date: Dec. 6, 2007

(54) System, apparatus, and methods for performing state-based authentication

(75) Inventors: Jihong Chen, Boca Raton, FL (US); Sam Hsu, Boca Raton, FL (US); Saeed Rajput, Coral Springs, FL (US)

Correspondence Address: AKERMAN SENTERFITT, P.O. BOX 3188, WEST PALM BEACH, FL, 33402-3188, US

(73) Assignee: Florida Atlantic University, Boca Raton, FL (US)

(21) Appl. No.: 11/344,894

(22) Filed: Feb. 1, 2006

Related U.S. Application Data
(60) Provisional application No. 60/648,912, filed on Feb. 1, 2005.

(51) Int. Cl. G06F 7/04

(52) U.S. Cl. 726/3

(57) ABSTRACT

A system for authenticating access to a data processing device or database is provided. The system includes a comparison module for comparing an attempt identifier with an account identifier, and a state-determining module for determining a state variable associated with at least one of the attempt identifier and the account identifier. The state-determining module determines the state variable by incrementing the state variable if the attempt identifier does not match the account identifier and if the state variable is less than a predetermined upper bound threshold, decrementing the state variable if the attempt identifier does match the account identifier and if the state variable is greater than a predetermined lower bound threshold, and authenticating the attempt identifier if the attempt identifier does match the account identifier and if the state variable equals the predetermined lower bound threshold.

### CROSS-REFERENCE TO RELATED APPLICATIONS

This application claims the benefit of U.S. Provisional Application No. 60/648,912, filed in the United States Patent and Trademark Office on Feb. 1, 2005, the entirety of which is incorporated herein by reference.

### BACKGROUND

1. Field of the Invention

The present invention is related to the field of data processing and data communication systems, and, more particularly, to safeguarding access to such systems.

2. Description of the Related Art

Data processing and data communications have become a ubiquitous feature of business, education, and a host of other activities. As more and more users employ various types of computing devices to perform an ever-increasing number of data processing and data communication functions, the need to protect such devices and the networks into which they are integrated grows. A major aspect of protection concerns preventing illicit users from gaining access to the various types of data processed with such devices and communicated over various data communications networks.

In a modern computing environment, data that needs to be protected from illicit users ranges from commercially valuable trade secrets to personal financial and academic records to a host of sensitive governmental and business documents, all stored electronically. Such data may reside on a stand-alone computing device such as a personal computer (PC), on a remotely-accessible special-purpose device such as a server, or any one of a number of other devices to which one or more users need periodic access. In most instances, security is based on preventing a user's gaining access to a computing device or data stored thereon unless the user electronically submits a predetermined password.

For example, in data communications networks such as the Internet and various local area networks (LANs), e-commerce websites and file transfer systems typically employ secure protocols to reduce the risk of on-line attacks. Such protocols typically implement a simple algorithm according to which the number of times an incorrect password can be entered is limited. The intent of such protocols is to make it more difficult for an illicit user to gain access by guessing the correct password.

Notwithstanding wide-spread use of such password-based authentication techniques, many if not most password-protected devices and databases remain at least somewhat vulnerable to attack. This is especially so given that various techniques for circumventing password protection have increased in both number and sophistication over time. One well-known technique is the so-called dictionary attack that reduces the complexity of password breaking by carefully choosing potential passwords from among lists of words known to be frequently used. A list, for example, may contain less than 100,000 strings, which with current computing capabilities can often be tested in a mere matter of seconds. Another technique, often referred to as syllable attacking, looks for and combines syllables rather than words. Syllable attacking can be effective when a password is constructed from deformed or nonsensical words. Still another technique belongs to the class of rule-based attacks and utilizes inside information that may be known to an attacker. For instance, if it is known that a password is constructed from using word forms followed by a two-digit number, then a rule-based attack may try various word-number combinations in rapid succession, such as user1, mind67, snapshot99 and similar structures. A rule-based attack can be successful in narrowing the password search space, thereby increasing the chance that access defenses can be breached.

A typical approach for mitigating the risk posed by these various attacks is to enforce so-called strong passwords, passwords that by virtue of their complexity and/or arbitrariness are difficult to guess. This gives rise, however, to a related problem that has persisted with password-based authentication techniques: the inevitable trade-off between greater protection through strong password enforcement versus the drain on system administrator resources that typically accompanies such enforcement. Specifically, to the degree that a password is difficult to break, it likely is more difficult to remember and/or enter correctly. If as a result, a legitimate user inadvertently “locks-up” a device or network, he or she typically calls upon the system administrator for help in remedying the situation. This can lead to a system administrator's spending an inordinate amount of time undoing erroneous locking that may be a by-product of strong password protection.

Accordingly, there remains a need for enhancing access protection for secured computing devices and databases, while also avoiding placing inordinate demands on a system administrator. More particularly, there is a need for a device and/or technique that provides enhanced access protection while conserving system administrator resources.

### SUMMARY OF THE INVENTION

The present invention provides a system, apparatus, and related methods for enhanced access protection that provides the additional feature of helping conserve system administrator resources.

A method for authenticating access to a data processing device or database, according to one embodiment of the invention, can include comparing an attempt identifier with an account identifier. The method can also include incrementing a state variable associated with the attempt identifier if the attempt identifier does not match the account identifier and if the state variable is less than a predetermined upper bound threshold. The method further can include decrementing the state variable if the attempt identifier does match the account identifier and if the state variable is greater than a predetermined lower bound threshold. The method additionally can include authenticating the attempt identifier if the attempt identifier does match the account identifier and if the state variable equals the predetermined lower bound threshold.

A system according to another embodiment of the present invention can include a comparison module for comparing an attempt identifier with an account identifier. The system also can include a state-determining module for determining a state variable associated with at least one of the attempt identifier and the account identifier. The state-determining module, moreover, can determine the state variable by incrementing the state variable if the attempt identifier does not match the account identifier and if the state variable is less than a predetermined upper bound threshold; decrementing the state variable if the attempt identifier does match the account identifier and if the state variable is greater than a predetermined lower bound threshold; and authenticating the attempt identifier if the attempt identifier does match the account identifier and if the state variable equals the predetermined lower bound threshold.

An apparatus according to still another embodiment of the present invention can comprise a computer-readable storage medium for use in authenticating access to a data processing system. The storage medium can include computer instructions for performing the following computer-based operations: comparing an attempt identifier with an account identifier; incrementing a state variable associated with the attempt identifier if the attempt identifier does not match the account identifier and if the state variable is less than a predetermined upper bound threshold; decrementing the state variable if the attempt identifier does match the account identifier and if the state variable is greater than a predetermined lower bound threshold; and authenticating the attempt identifier if the attempt identifier does match the account identifier and if the state variable equals the predetermined lower bound threshold.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a data processing environment including a system for authentication according to one embodiment of the present invention.

FIG. 2 is a schematic diagram illustrating operative features of a system for authentication according to another embodiment of the present invention.

FIG. 3 is a flowchart illustrative a method for performing authentication according to still another embodiment of the present invention.

### DETAILED DESCRIPTION OF THE INVENTION

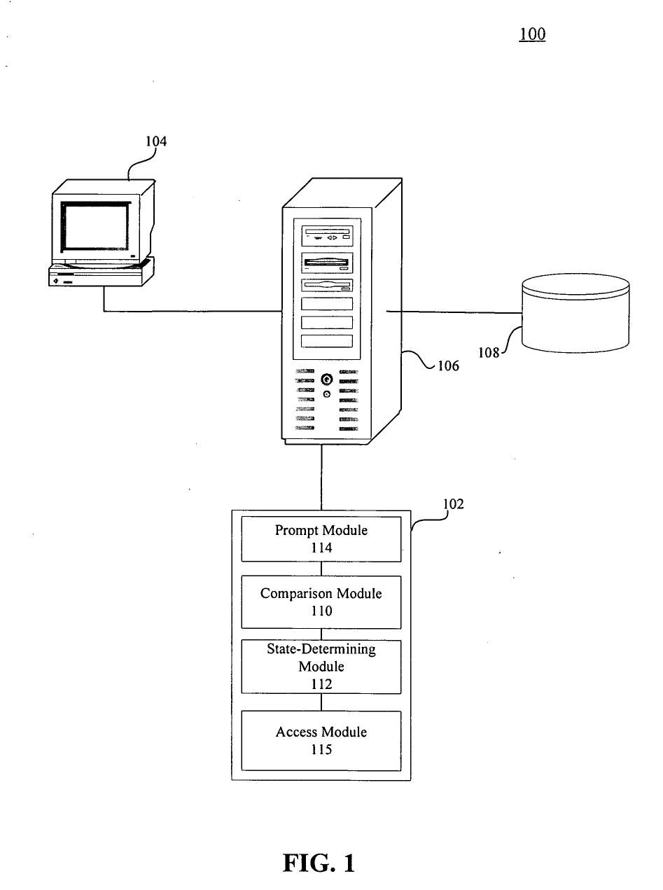

FIG. 1 is a schematic diagram of a data processing environment 100 that includes a system 102 for authenticating access to a data processing device or database according to one embodiment of the present invention. The data processing environment also illustratively includes a general-purpose computing device 104, a server 106 in communication with the computing device, and a database 108 in communication with the server. As will be readily apparent from the ensuing discussion, the data processing environment 100 is merely exemplary and represents but one of the numerous different data processing, computing, and communication environments in which the system 102 can be employed for authenticating access to a data processing device or database.

The system 102, more particularly, illustratively comprises a comparison module 110 and, in electronic communication with the comparison module, a state-determining module 112. In addition, a prompt module 114 is illustratively connected to the comparison module 110, and an access module 115 is illustratively connected to the state-determining module 112.

The comparison module 110, state-determining module 112, prompt module 114, and access module 115 each illustratively comprises distinct software-based instructions, written in a high-level computing language or other machine-readable code. The instructions are illustratively stored in a memory (not shown) and processed by a central processing unit (not shown) for executing the functional operations as explained herein. In an alternative embodiment, one or more of the comparison module 110, state-determining module 112, prompt module 114, and access module 115 are embodied in dedicated, hard-wired circuitry connected to or incorporated in the circuitry of the server 106. In still another embodiment, one or more of the comparison module 110, state-determining module 112, prompt module, and access module 115 are embodied in a combination of hard-wired circuitry and machine-readable code for effecting the functional operations preformed by the system 102.

Moreover, although the system 102 illustratively resides on the server 106, it is to be understood that in an alternative embodiment, the system 102 resides on the general-purpose computing device 104. In yet another embodiment, the system 102 is embodied in a computer-readable storage medium independent of a specific device, the system being loaded on the specific device for performing the functions in the manner described herein.

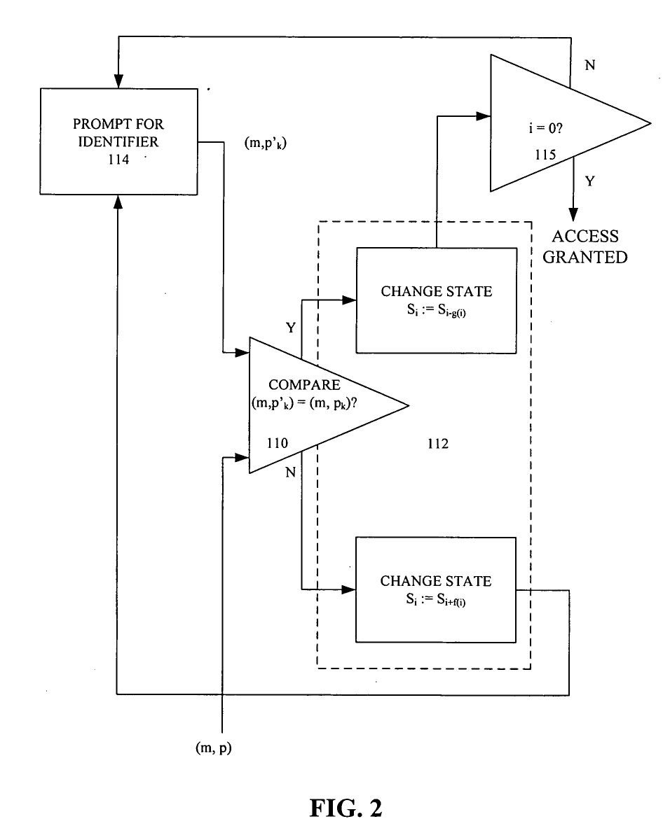

Referring additionally to FIG. 2, the operational functions performed by the system 102 according to one embodiment are illustrated. Initially, a user of the general-purpose computing device 104 attempts to access the server 106 on which the system 102 illustratively resides. The prompt module 114 of the system prompts the user to enter a character string or other data, which as described herein is defined as an attempt identifier. More particularly, the attempt identifier can comprise an attempt usemame and an attempt password. The attempt identifier illustratively comprises an attempt username and attempt password as represented by the 2-tuple, (m,p′ₖ), where m and P′ₖ represent the attempt username and attempt password, respectively. The subscript of the attempt password indicates a k-th state of a state variable as defined below.

The comparison module 114 compares the attempt identifier, (m,p′ₖ) with an account identifier, (m,p). The account identifier, (m,p), also can comprise a character string or other data indicating a legitimate user. More particularly, the account identifier, (m,p), represents a stored account usemame and stored account password. Illustratively, the account identifier (m,p) is stored in the database 108 that is in communication with the server 106. In an alternative embodiment, the database 108 resides on the server 106. In yet another embodiment, the database resides on the computing device 102.

The state-determining module 112 determines a state variable corresponding to a state associated with the account identifier. The state variable reflects the number of attempts made to access the account identified by the account identifier. Each such attempt corresponds to a user's entering an attempt identifier. In determining the state variable representative of a current state for the account, the state-determining module 112 increments the state variable if the attempt identifier does not match the account identifier and if the state variable is less than a predetermined upper bound threshold. Conversely, if the attempt identifier does match the account identifier and if the state variable is greater than a predetermined lower bound threshold, the state-determining module 112 decrements the state variable. Only when the attempt identifier matches the account identifier and the state variable equals the predetermined lower bound threshold, does the state-determining module 112 authenticate the attempt identifier. Without such authentication, a user is unable to access the account identified by the account identifier.

Accordingly, an account protected by the system 102 has a state, sᵢ. According to one embodiment, states are fully ordered such that sᵢ<sⱼ if i<j; sᵢ=sⱼ only if i=j. Thus, the system 102 can provide a one-to-one mapping between a set of integers and corresponding states. The state variable thus indicates the particular state, at any moment, of the corresponding account. For each attempt to access the account, as already noted, the state variable is incremented. More particularly, the state variable can be incremented according to a particular function f(i), where i is an integer that serves to index a particular state as described. Accordingly, after an unsuccessful attempt to access the account owing to a non-match between the attempt identifier and the account identifier, the state-determining module 112 changes the state variable from sᵢ to s_{i+f(i)}. Conversely, a successful match results in a decrement of the state variable from sᵢ to s_{i-g(i)}.

As already noted, authentication require both that the attempt identifier match the account identifier and that the state variable equals the predetermined lower bound threshold. Accordingly, each illicit attempt to circumvent protection by guessing the correct account identifier raises the defensive barrier afforded by the system 102. An easily envisioned scenario illustrates this iteratively strengthening defense. Assume that for an attacker attempting to illicitly access a device or database, the probability of a correct guess of the account identifier is p. The probability that the attacker fails to breach the defense on the first attempt is accordingly 1-p, a very high probability given that p under most conditions is quite small. The probability that the attacker can guess the true account identifier remains low even on subsequent attempts. But moreover, with every additional attempt, the state variable is incremented by the state-determining module 112 so that even if at some point the attacker does succeed in correctly guessing the true account identifier, the system 102 requires that the attacker submit that same identifier (i.e., the attempt identifier) enough times to decrement the state variable down to the lower bound threshold, s₀.

At this point, however, the attacker has no way of ascertaining whether the guess in fact was correct; the attacker can not be sure whether the better strategy is to try an alternate guess or re-submit the previous one a sufficient number of times to decrement the state variable down to the lower bound threshold. Accordingly, the attacker is more likely to continue strengthening the defense barrier with submission of additional, albeit incorrect, attempt identifiers. At a the upper bound threshold, sₘₐₓ, the state-determining module 112 can cease incrementing the state variable. An attacker remains saddled with that state for the account and can not change that state until and if the attacker both makes a correct guess and is able to ascertain that the guess is in fact correct. The attacker, however, has no way to know when a correct guess has been made since the system requires multiple submissions of the correct identifier.

Contrast this scenario with that of a legitimate user who mistakenly submits the wrong attempt identifier. The legitimate user knows the correct identifier and is able to submit it the necessary multiple times to ensure that state variable is decremented by the state determining module 112 as needed to meet the above-stated conditions for authentication.

The particular functions f(i) and g(i) utilized by the state-defining module 112 can be selected according to the security requirements of the environment in which the system 102 is employed. Each can, according to one embodiment, be set equal to a constant; for example, each may be equal to one so that each attempt results in the state variable be incremented by one or decremented by one provided that the current state variable is sufficiently with the limits set by the upper and lower bound thresholds. According to another embodiment, defense against attacks to gain illicit access are heightened by setting the function f(i) to be greater than one. Indeed, the function f(i) can be a linear function such that the state variable increases by k with each entry of an incorrect attempt identifier.

According to still another embodiment, the function f(i) can increase exponentially with each submission of an incorrect attempt identifier. For example, a non-linear form can be defined by the equation f(i)=└A+Be^{αi}┘, where i represents an i-th state, where A, B, and α are predetermined real-valued constants, and e is 2.71828183, the base of natural logarithms. This form increases the state variable rapidly so that an illicit attacker more quickly runs up against the upper bound threshold the higher the state, while keeping transitions small for small-valued i's.

More generally, according to yet another embodiment, the state-determining module 112 increments the state variable from a lower state to a higher state according to a deterministic finite accepter (DFA). The DFA can be defined by a state domain, a checked account identifier domain, a state transition function, and an acceptable state domain. Accordingly, the DFA, M, is defined as follows:
M=(Q,Σ,δ,0,F),
where Q is a finite set of integers including the upper bound threshold; Σ is a checked identifier domain comprising the set {1,0}; F={0}; and δ is a state transfer function. The state transfer function is a mapping defined as δ=Q×Σ→Q. In general, the transition function depends on an input alphabet value and the current state i:
δ=(0,1)εQ;
δ(i,1)=(i31 1)εQ,0<i ≦max;
δ(max,0)=max εQ; and
δ(i,0)=k=A*power(x,i)εQ,0≦i<max.
The parameter A is an enlarge factor and x is a speed factor.

Moreover, a high defense can be further maintained by constraining the state-defining module 112 in the decrement of the state variable with each entry of a correct or matching attempt identifier. For example, the function g(i) can be a constant function equal to one, so that each correct or matching entry reduces the state downward in only unit decrements.

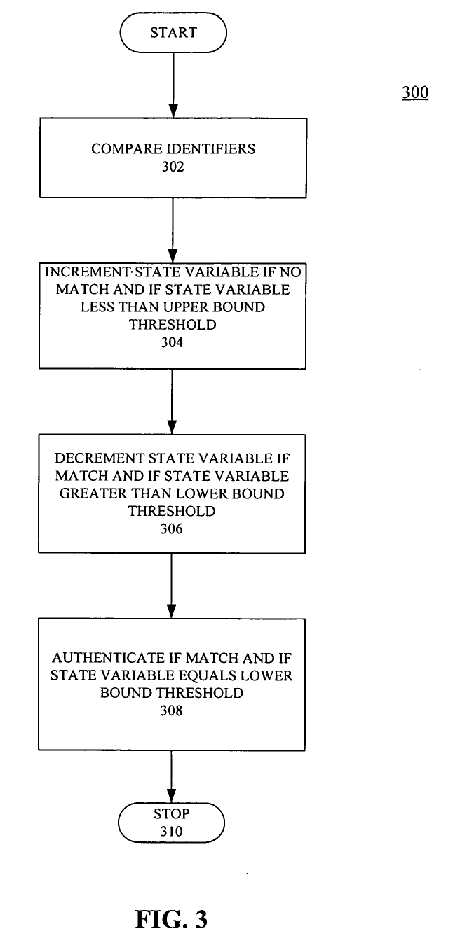

FIG. 3 is a flowchart illustrating a method aspect of the invention. As illustrated, the method 300 includes at step 302 comparing an attempt identifier with an account identifier. The method continues at step 304 by incrementing a state variable associated with the attempt identifier if the attempt identifier does not match the account identifier and if the state variable is less than a predetermined upper bound threshold. The method further includes, at step 306, decrementing the state variable if the attempt identifier does match the account identifier and if the state variable is greater than a predetermined lower bound threshold. At step 308, the method includes authenticating the attempt identifier if the attempt identifier does match the account identifier and if the state variable equals the predetermined lower bound threshold. The method illustratively concludes at step 310.

As already described, various aspects of the present invention can be realized in hardware, software, or a combination of hardware and software. Accordingly, the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

That which is claimed is:

1. A method for authenticating access to a data processing device or database, the method comprising the steps of:
comparing an attempt identifier with an account identifier;
incrementing a state variable associated with the attempt identifier if the attempt identifier does not match the account identifier and if the state variable is less than a predetermined upper bound threshold;
decrementing the state variable if the attempt identifier does match the account identifier and if the state variable is greater than a predetermined lower bound threshold; and
authenticating the attempt identifier if the attempt identifier does match the account identifier and if the state variable equals the predetermined lower bound threshold.

2. The method of claim 1, wherein the step of incrementing comprises changing the state variable from a lower state to a higher state, the higher state being determined based upon a predefined integer function.

3. The method of claim 2, wherein the predefined integer function is a constant over all states.

4. The method of claim 1, wherein the step of incrementing comprises changing the state variable from a lower state to a higher state, the higher state being determined based upon a non-linear function.

5. The method of claim 4, wherein the non-linear function is an exponential function.

6. The method of claim 4, wherein the non-linear function is defined by the equation f(i)=└A+Be^{αi}┘, where i represents an i-th state, where A, B, and α are predetermined real-valued constants, and e is a natural logarithm base.

7. The method of claim 6, wherein the step of incrementing comprises changing the state variable from a lower state to a higher state, the higher state being determined based upon a deterministic finite accepter (DFA) defined by a state domain, a checked account identifier domain, a state transition function, and an acceptable state domain.

8. A system for authenticating access to a data processing device or database, the system comprising:
a comparison module for comparing an attempt identifier with an account identifier;
a state-determining module for determining a state variable associated with at least one of the attempt identifier and the account identifier, the state-deternining module determining the state variable by
incrementing the state variable if the attempt identifier does not match the account identifier and if the state variable is less than a predetermined upper bound threshold,
decrementing the state variable if the attempt identifier does match the account identifier and if the state variable is greater than a predetermined lower bound threshold, and
authenticating the attempt identifier if the attempt identifier does match the account identifier and if the state variable equals the predetermined lower bound threshold.

9. The system of claim 8, further comprising a prompt module for prompting a user to provide the attempt identifier.

10. The system of claim 8, further comprising an access module for providing access to the data processing device or database when the state-determining module authenticates the attempt identifier.

11. The system of claim 8, wherein the state-determining module changes the state variable from a lower state to a higher state based upon a predefined integer function.

12. The system of claim 8, wherein the state-determining module changes the state variable from a lower state to a higher state based upon a predefined non-linear function.

13. The system of claim 12, wherein the non-linear function is defined by the equation f(i)=└A+Be^{αi}┘, where i represents an i-th state, where A, B, and α are predetermined real-valued constants, and e is a natural logarithm base.

14. The system of claim 8, wherein the state-determining module changes the state variable from a lower state to a higher state based upon based upon a deterministic finite accepter (MFA).

15. A computer-readable storage medium for use in authenticating access to a data processing system, the storage medium comprising computer instructions for:
comparing an attempt identifier with an account identifier;
incrementing a state variable associated with the attempt identifier if the attempt identifier does not match the account identifier and if the state variable is less than a predetermined upper bound threshold;
decrementing the state variable if the attempt identifier does match the account identifier and if the state variable is greater than a predetermined lower bound threshold; and
authenticating the attempt identifier if the attempt identifier does match the account identifier and if the state variable equals the predetermined lower bound threshold.

16. The computer-readable storage medium of claim 15, wherein incrementing comprises changing the state variable from a lower state to a higher state, the higher state being determined based upon a predefined integer function.

17. The computer-readable storage medium of claim 16, wherein the predefined integer function is a constant over all states.

18. The computer-readable storage medium of claim 15, wherein incrementing comprises changing the state variable from a lower state to a higher state, the higher state being determined based upon a non-linear function.

19. The computer-readable storage medium of claim 18, wherein the non-linear function is an exponential function.

20. The computer-readable storage medium of claim 18, wherein the non-linear function is defined by the equation f(i)=└A+Be^{αi}┘, where i represents an i-th state, where A, B, and α are predetermined real-valued constants, and e is a natural logarithm base.
